(19) United States
(12) Patent Application Publication
(10) Pub. No.: US 2008/0317514 A1
(43) Pub. Date: Dec. 25, 2008

(54) Image forming apparatus

(75) Inventor: Masashi Fujishima, Osaka (JP)

Correspondence Address: THE WEBB LAW FIRM, P.C., 700 KOPPERS BUILDING, 436 SEVENTH AVENUE, PITTSBURGH, PA, 15219, US

(73) Assignee: KYOCERA MITA CORPORATION, Osaka (JP)

(21) Appl. No.: 11/974,916

(22) Filed: Oct. 16, 2007

(30) Foreign Application Priority Data
Oct. 19, 2006 (JP) JP2006-285148

(51) Int. Cl. G03G 15/08

(52) U.S. Cl. 399/286

(57) ABSTRACT

The present invention provides an image-forming apparatus comprising a magnetic roll for magnetically holding a two-component developer in which toner and a magnetic carrier are electrostatically bonded, a developing roll in which a thin layer of the toner transferred from the two-component developer on the magnetic roll is formed on the surface, and a latent image support in which a latent image is developed with using the toner on the developing roll by a developing bias applied in relation to the developing roll, wherein the developing roll has a coating layer composed of silicone-modified polyurethane on a surface.

### BACKGROUND OF THE INVENTION

1. Field of the Invention

The present invention relates to an image-forming apparatus comprising a magnetic roll for magnetically holding a two-component developer in which toner and a magnetic carrier are electrostatically bonded, a developing roll in which a thin layer of toner transferred from the two-component developer on the magnetic roll is formed on the surface, and a latent image support in which a latent image is developed with using the toner on the developing roll by a developing bias applied in relation to the developing roll.

2. Description of the Related Art

There are electrophotographic image forming apparatuses comprising a magnetic roll for magnetically holding a two-component developer in which toner and a magnetic carrier are electrostatically bonded, a developing roll in which a thin layer of toner transferred from the two-component developer on the magnetic roll is formed on the surface, and a latent image support in which a latent image is developed with using the toner on the developing roll by a developing bias applied in relation to the developing roll (See JP-A2003-280357, for an example.). When a two-component developer is used, the life of the apparatus can be extended and the quality of the captured images can be improved.

When preparing the aforementioned two-component developer for the image-forming apparatus described in JP-A2003-280357, the toner and the magnetic carrier are mixed together, then stirred. The two components are frictionally charged and electrostatically bonded. The electrostatic force between the toner and the magnetic carrier is adjusted to a sufficiently high level in order to prevent toner from scattering away from the magnetic carrier in the two-component developer held on the magnetic roll. In other words, the electric charge on the toner is adjusted to a sufficiently high level. As a result, the toner is transferred from the magnetic roll to the developing roll in a state in which the electric charge is maintained substantially unchanged. Bias voltage is applied between the developing roll and the latent image support in order to transfer the charged toner from the two-component developer held by the magnetic roll onto the developing roll.

The characteristics required of image-forming apparatuses include higher speed in addition to longer life and improved image quality as mentioned above. To achieve the higher speed, it is necessary to rapidly rotate the magnetic roll, the developing roll, and the latent image support. Quick rotation, however, presents the problem of toner scattering. This especially applies when the magnetic roll is quickly rotated, causing the toner in the two-component developer being held on the magnetic roll to scatter off of the magnetic carrier.

Increasing the electrostatic force between the toner and the magnetic carrier, i.e., increasing the toner charge, is sufficient for preventing the toner on the magnetic roll from scattering. Because the toner is transferred from the magnetic roll onto the developing roll in a state in which the electric charge is maintained substantially unchanged in this case, the electric charge on the toner which is bonded onto the developing roll is increased as well.

However, if the electric charge on the toner on the developing roll is increased, a problem arises where it is difficult to separate the toner from the developing roll without increasing the developing bias and to control the transfer of the toner from the developing roll to the latent image support. In other words, it becomes difficult to control the developing of a latent image with the toner. Problems such as poor image density or ghosts caused by the toner scraping defects that do not contribute to image developing therefore occur.

### SUMMARY OF THE INVENTION

The image-forming apparatus according to one aspect of the present invention designed to attain the aforementioned object comprises a magnetic roll for magnetically holding the two-component developer in which toner and a magnetic carrier are electrostatically bonded, a developing roll in which a thin layer of the toner transferred from the two-component developer on the magnetic roll is formed on a surface, and a latent image support in which the latent image is developed with using the toner on the developing roll by a developing bias applied in relation to the developing roll, wherein the developing roll has a coating layer composed of silicone-modified polyurethane on a surface.

In the image-forming apparatus according to another aspect of the present invention, the coating layer composed of the silicone-modified polyurethane has a surface specific resistivity of 10⁵ to 10⁸Ω.

In the image-forming apparatus according to still another aspect of the present invention, the coating layer composed of the silicone-modified polyurethane has a surface roughness Ra of 0.4 to 1.5 μm.

In the image-forming apparatus according to still another aspect of the present invention, the coating layer composed of the silicone-modified polyurethane has a surface specific resistivity of 10⁵ to 10⁸Ω and a surface roughness Ra of 0.4 to 1.5 μm.

In the image-forming apparatus according to still another aspect of the present invention, an alternating-current bias is applied to the developing roll.

In the image-forming apparatus according to still another aspect of the present invention, the peripheral speed of the latent image support is 180 mm/sec or greater.

### BRIEF DESCRIPTION OF THE DRAWINGS

FIG. 1 is a schematic diagram of the image-forming apparatus;

FIG. 2 is a schematic diagram of the developer unit provided to the image-forming apparatus;

FIG. 3 is a graph in which experimental results show the relationship between the level of the bias voltage between the developing roll and a photoreceptor and the amount of toner transferred from the developing roll to the photoreceptor; and

FIG. 4 is a graph in which experimental results show the relationship between the level of the bias voltage between the developing roll and the photoreceptor per peripheral speed (rotational velocity) of the photoreceptor (bias voltage/peripheral speed of the photoreceptor) and the amount of toner transferred from the developing roll to the photoreceptor.

### DETAILED DESCRIPTION OF THE PREFERRED EMBODIMENTS

Preferred embodiments of the present invention are described below with reference to the drawings.

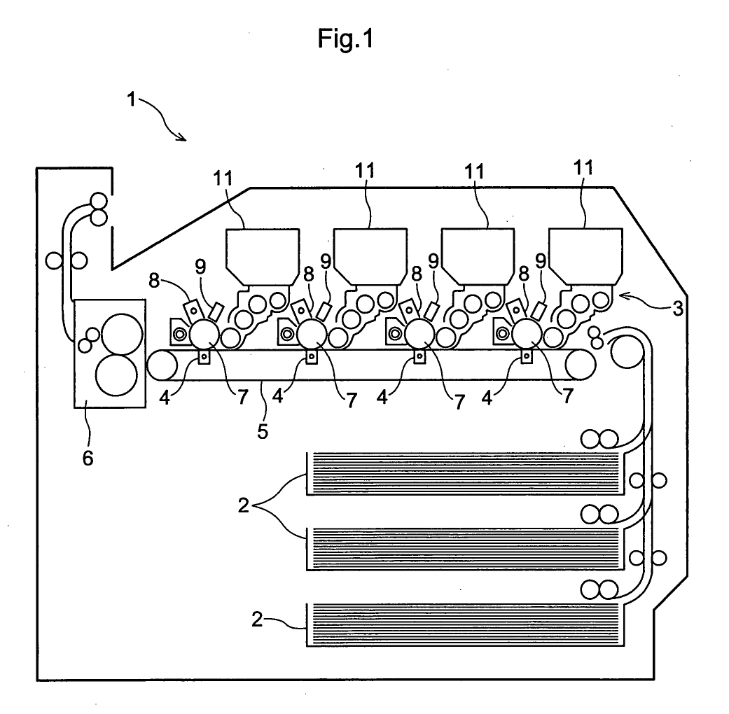

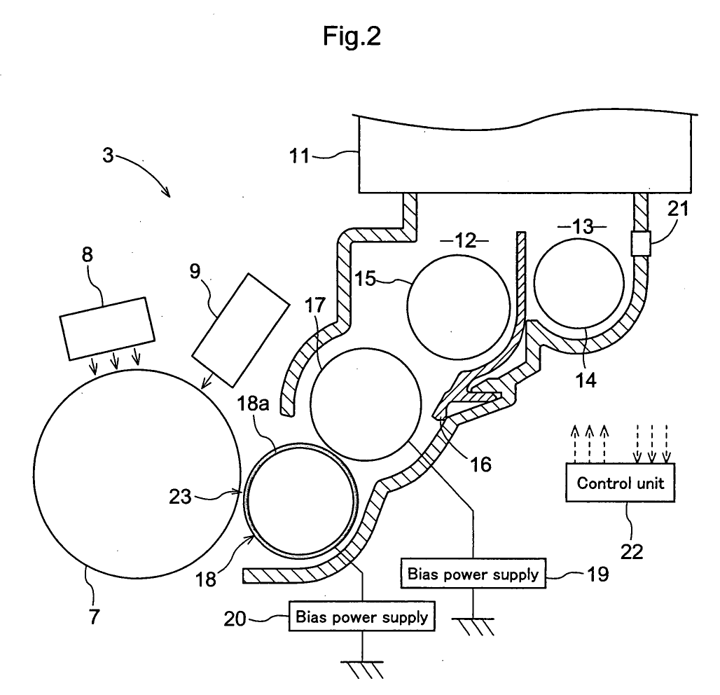

FIG. 1 is a schematic diagram of an image-forming apparatus 1, and FIG. 2 is a schematic diagram of a developer unit 3 provided to the image-forming apparatus 1.

As shown in FIG. 1, in the image-forming apparatus 1, a toner image developed in the photoreceptor 7 as a latent image support by a developer unit 3 is transferred in a transfer unit 4 to a recording medium fed from a paper feeder unit 2. A recording medium such as paper is transported to a fixing unit 6 by a transport unit 5, and is ejected out from the apparatus after the transferred toner is fused onto the recording medium. In the image-forming apparatus 1 of the present embodiment, a 4-set developer unit 3, a developer container 11, and a transfer unit 4 are provided, and the four colors of toner (developer) placed in each developer container can be printed onto the recording medium.

As shown in FIG. 2, the developer unit 3 comprises a magnetic roll 17 for magnetically holding a two-component developer in which toner and a magnetic carrier are electrostatically bonded, a developing roll 18 in which a thin layer of toner transferred from the two-component developer on the magnetic roll 17 is formed on the surface, and a photoreceptor 7 in which a latent image is developed with using the toner on the developing roll 18 by a developing bias applied in relation to the developing roll 18. A paddle mixer 15 having paddle-type stirring blades is provided to a first developer stirring chamber 12, and a stirring mixer 14 having ribbon-type stirring blades is provided to a second developer stirring chamber 13. In the present embodiment, the toner particle diameter (volume mean particle diameter) is 7.5 μm, and the carrier particle diameter (weight mean particle diameter) is 45 μm. The electric charge on the toner on the surface of the developing roll is 25 μC/g.

The toner used in the present embodiment comprises an internal additive and an external additive. The compositions of the internal additive and external additive are described below.

### <Internal Additive>

Polyester resin: 100 parts by mass

Carnauba wax: 10 parts by mass

Quinacridone pigment: 4 parts by mass

Quaternary ammonium: 2 parts by mass

### <External Additive>

Toner particles: 100 parts by mass

Hydrophobic silica microparticles: 1 part by mass

Titanium oxide microparticles: 0.5 part by mass

A sensor unit 21 having a plurality of sensors is provided to the inner wall of the second developer stirring chamber 13 so as to be exposed inside the second developer stirring chamber 13. The sensors include a toner density sensor, a temperature sensor, and a humidity sensor. Of the aforementioned sensors, the toner density sensor is a sensor for measuring permeability. The control unit 22 references the permeability and determines the toner density, i.e., the ratio of toner and magnetic carrier. In the control unit 22, the fact that the charge state of the toner varies depending on temperature and humidity is taken into account, the measurement results of the temperature sensor and humidity sensor, as well as the stirring state of the stirring mixer 14 and paddle mixer 15, are referenced, and the electric charge on the toner is determined.

A charge unit 8 for applying a charge to the photoreceptor 7, and an exposure unit 9 for forming a latent image on the surface of the charged photoreceptor 7 are provided facing the surface of the photoreceptor 7. The charge unit 8 has a discharger (not shown) for generating corona discharges and the like, and the surface of the photoreceptor 7 is charged by the discharges. Also provided are a bias power supply 19 for applying a predetermined potential to the surface of the magnetic roll 17, and a bias power supply 20 for providing a predetermined potential to the surface of the developing roll 18. The bias power supply 19 and the bias power supply 20 are controlled by the control unit 22 to adjust the bias between the magnetic roll 17 and the developing roll 18, and the developing bias between the developing roll 18 and the photoreceptor 7. Charge control means (not shown) for controlling the electric charge on the toner in a developing nip portion 23 on the developing roll 18 can also be provided facing the surface of the developing roll 18. A charge removal unit as the charge control means may be implemented as an apparatus which is provided with a discharger similar to that provided to the charge unit 8, and in which the electric charge of the toner in the developing nip portion 23 on the developing roll 18 is neutralized using the electric charge (a charge whose polarity is opposite to that of the toner) emitted by allowing the discharger to discharge.

A mechanism for forming a latent toner image on the surface of the photoreceptor 7 in the developer unit 3 of the image-forming apparatus 1 is described below.

The magnetic carrier inside the first developer stirring chamber 12 and the second developer stirring chamber 13, and the toner introduced from the developer container 11 into the first developer stirring chamber 12 and the second developer stirring chamber 13 are mixed together in the first developer stirring chamber 12 and the second stirring chamber 13 by the paddle mixer 15 and the stirring mixer 14. A predetermined electric charge is thereby provided to the toner by way of frictional charging between the toner and the magnetic carrier. The electric charge on the toner is adjusted by the extent to which stirring is performed by the paddle mixer 15 and the stirring mixer 14.

Increasing the electric charge on the toner is preferable to prevent the toner from scattering when the image-forming apparatus 1 runs at a higher speed. This is because when the magnetic roll 17 rotates at a high speed, the toner in the two-component developer being held by the magnetic roll 17 scatters from the magnetic carrier.

The two-component developer in which the magnetic carrier and the toner are stirred and electrostatically bonded is transported to the magnetic roll 17, and the magnetic carrier in the two-component developer is magnetically attracted and bonded by the magnetic force of the magnetic roll 17. The two-component developer bonded to the magnetic roll 17 is arranged by the magnetic force of the magnetic roll 17 into rows composed of a plurality of particles, forming so-called magnetic brushes. In other words, the magnetic roll 17 rotates in a state in which a large number of magnetic brushes are bonded to the surface of the roll. A restricting blade 16 for restricting the height of the magnetic brushes (the distance from the surface of the magnetic roll 17) to a set height is provided near the magnetic roll 17. As a result, the height of the magnetic brushes facing towards the developing roll 18 can be kept at an optimum level when the magnetic roll 17 rotates and the magnetic brushes extending away from the magnetic roll 17 come into contact with the developing roll 18.

A predetermined bias is applied by the control unit 22 between the magnetic roll 17 and the developing roll 18, and only the charged toner not attracted by the magnetic force of the magnetic roll 17, which is part of the two-component developer held on the surface of the magnetic roll 17, is transferred to the surface of the developing roll 18. The magnetic brushes formed by the particles of the two-component developer are adjusted to a height at which contact is achieved with the developing roll 18, as described above. Therefore, the bias needed to transfer the toner onto the surface of the developing roll 18 can be reduced. The toner on the surface of the developing roll 18 can be formed into a uniform layer and can subsequently be used to develop a latent image on the photoreceptor 7.

The developing bias between the developing roll 18 and the photoreceptor 7 is adjusted by the control unit 22 when the toner on the surface of the developing roll 18 is transferred to the surface of the photoreceptor 7. When the electric charge on the toner is increased in order to attain faster operation of the image-forming apparatus 1, transferring the toner bonded onto the surface of the developing roll 18 from to the surface of the photoreceptor 7 might be difficult.

Therefore, in the image-forming apparatus 1 of the present embodiment, the developing roll 18 has a coating layer 18a composed of silicone-modified polyurethane on a surface thereof. As a result, transferring the toner from the developing roll 18 to the surface of the photoreceptor 7 is made relatively easy. Specifically, the silicone-modified polyurethane used as the coating layer 18a formed on the surface of the developing roll 18 is adjusted to a surface specific resistivity of 10⁵ to 10⁸Ω and a surface roughness Ra of 0.4 to 1.5 μm. The surface free energy of the silicone-modified polyurethane is 15 to 25 mJ/cm².

The surface specific resistivity of the coating layer 18a in the present embodiment was measured using a digital electrometer made by ADVANTEST Corporation. To increase the contact area between the coating layer 18a and the digital electrometer and to reduce the resistance existing between the coating layer 18a and the digital electrometer, an electrically conductive sheet was interposed between the coating layer 18a and the digital electrometer. The surface specific resistivity of the coating layer 18a was measured with a bias voltage of 100 V being applied between the coating layer 18a and the digital electrometer.

The surface roughness of the coating layer 18a was measured using the SURFCOM 1500DX made by ACCRETECH.

The ease of transferring the toner from the developing roll 18 to the photoreceptor 7 is explained by comparing examples 1 to 5 with comparative examples 1 to 5. In the aforementioned examples 1 to 5, the coating layer 18a formed on the surface of the developing roll 18 is composed of silicone-modified polyurethane, the surface specific resistivity of the coating layer 18a is 10⁵ to 10⁸Ω, and the surface roughness Ra thereof is adjusted to from 0.4 to 1.5 μm. The coating layer 18a in examples 1 to 5 and comparative examples 1 to 5 is prepared under the following conditions. In all cases, the coating layer 18a is formed by applying a coating agent to an aluminum pipe or anodizing the surface of the pipe. The surface specific resistivity of the coating layer 18a composed of silicone-modified polyurethane is adjusted by adding adequate doses of a resistance modifier such as acetylene black to the coating agent in the coating layer 18a. A coating layer having a surface roughness Ra of 0.3 μm or 0.4 μm falls within the surface roughness range of a coating layer 18a typically obtained when applying the coating agent, and the surface roughness is selected from this range. A coating layer having an Ra of 1.0 μm, 1.5 μm, or 1.6 μm is created by adding a surface roughness modifier such as urethane beads to the coating agent.

### EXAMPLE 1

Developing roll in which a coating layer 18a composed of silicone-modified polyurethane is formed on the surface, the surface specific resistivity of the coating layer 18a is 10⁶Ω, and the surface roughness Ra is 1.0 μm

### EXAMPLE 2

Developing roll in which a coating layer 18a composed of silicone-modified polyurethane is formed on the surface, the surface specific resistivity of the coating layer 18a is 10⁵ Ω, and the surface roughness Ra is 1.0 μm

### EXAMPLE 3

Developing roll in which a coating layer 18a composed of silicone-modified polyurethane is formed on the surface, the surface specific resistivity of the coating layer 18a is 10⁸ Ω, and the surface roughness Ra is 1.0 μm

### EXAMPLE 4

Developing roll in which a coating layer 18a composed of silicone-modified polyurethane is formed on the surface, the surface specific resistivity of the coating layer 18a is 10⁶Ω, and the surface roughness Ra is 0.4 μm

### EXAMPLE 5

Developing roll in which a coating layer 18a composed of silicone-modified polyurethane is formed on the surface, the surface specific resistivity of the coating layer 18a is 10⁶Ω, and the surface roughness Ra is 1.5 μm

### COMPARATIVE EXAMPLE 1

Developing roll in which a coating layer 18a composed of anodized aluminum (alumite) is formed on the surface, the surface specific resistivity of the coating layer 18a is 10⁶Ω, and the surface roughness Ra is 1.0 μm

### COMPARATIVE EXAMPLE 2

Developing roll in which a coating layer 18a composed of silicone-modified polyurethane is formed on the surface, the surface specific resistivity of the coating layer 18a is 10⁴Ω, and the surface roughness Ra is 1.0 μm

### COMPARATIVE EXAMPLE 3

Developing roll in which a coating layer 18a composed of silicone-modified polyurethane is formed on the surface, the surface specific resistivity of the coating layer 18a is 10⁹106 , and the surface roughness Ra is 1.0 μm

### COMPARATIVE EXAMPLE 4

Developing roll in which a coating layer 18a composed of silicone-modified polyurethane is formed on the surface, the surface specific resistivity of the coating layer 18a is 10⁶Ω, and the surface roughness Ra is 0.3 μm

### COMPARATIVE EXAMPLE 5

Developing roll in which a coating layer 18a composed of silicone-modified polyurethane is formed on the surface, the surface specific resistivity of the coating layer 18a is 10⁶Ω, and the surface roughness Ra is 1.6 μm

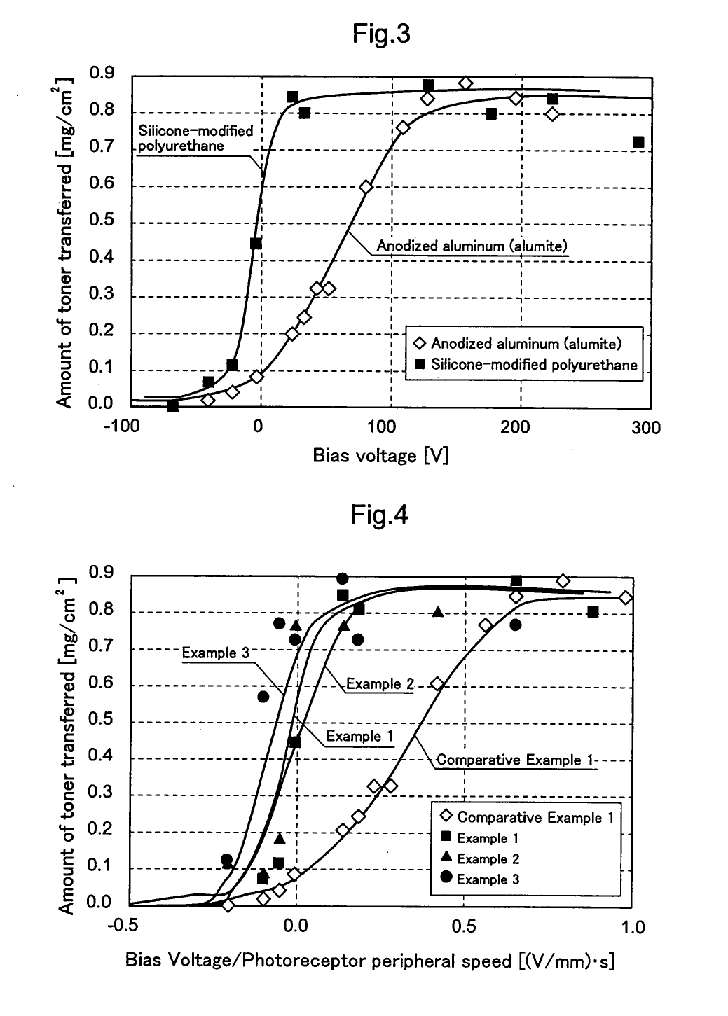

FIG. 3 is a graph in which experimental results show the relationship between the level of the bias voltage between the developing roll 18 and the photoreceptor 7 and the amount of toner transferred from the developing roll 18 to the photoreceptor 7. The coating layer 18a of the developing roll 18 is compared between a case in which the layer is as described in Example 1 and a case in which the layer is as described in Comparative Example 1. In Example 1, the coating layer 18a is formed using silicone-modified polyurethane, whereas in Comparative Example 1, a coating layer 18a is formed using anodized aluminum (alumite). In the other respects, these examples are the same.

A comparison experiment was performed under the following conditions using the structure shown in FIG. 2. The following bias was applied to the developing roll 18, the magnetic roll 17, and the photoreceptor 7 as a latent image support. The carrier particle diameter was 45 μm, the toner particle diameter was 7.5 μm, and the peripheral speed of the photoreceptor 7 was 180 mm/sec.

### Developing Roll

Direct-current bias (Vdc): 0 V

Alternating-current bias (Vpp): 1.6 kV, 2.7 kHz, Duty ratio=25%

### Magnetic Roll

Direct-current bias (Vdc): 200 V

Alternating-current bias (Vpp): 300 V, 2.7 kHz, Duty ratio=25%

### Photoreceptor

Direct-current bias (Vdc): −100 V to 300 V

Alternating-current bias (Vpp): 1.6 kV, 2.7 kHz, Duty ratio=75%

As shown in FIG. 3, in the case of the developing roll 18 wherein the coating layer 18a is composed of silicone-modified polyurethane (Example 1), a larger amount of toner is transferred from the developing roll 18 to the photoreceptor 7 with a lower bias voltage. In other words, the developing roll 18 using the silicone-modified polyurethane can be judged to have weaker adhesion to the toner. Also, adhesion between silicone-modified polyurethane or aluminum (seen as being similar to anodized aluminum (alumite)) and the toner was studied using the centrifugation method, and it was found that adhesion between silicone-modified polyurethane and the toner was 72 nN, whereas adhesion between aluminum and the toner was 106 nN. From this point also, it is possible to judge that the developing roll 18 using silicone-modified polyurethane has weaker adhesion to the toner. The toner used in these adhesion measurements had a particle diameter of approximately 10 μm, and no external additive such as silica or any other surface treatment agent was used.

Forming a coating layer 18a composed of silicone-modified polyurethane on the surface of the developing roll 18 in this manner is favorable for transferring toner from the developing roll 18 to the photoreceptor 7. The aforementioned difference in adhesion is believed to result from a difference in the surface free energy between the silicone-modified polyurethane and aluminum. For example, the surface free energy of silicone-modified polyurethane is about 15 to 25 mJ/cm², and the surface free energy of aluminum is about 500 mJ/cm². In other words, the adhesion between silicone-modified polyurethane and toner can be regarded to be relatively small compared with the adhesion between aluminum (anodized aluminum (alumite)) and toner.

FIG. 4 is a graph in which experimental results show the relationship between the level of the bias voltage between the developing roll 18 and a photoreceptor 7 per peripheral speed (rotational velocity) of the photoreceptor 7 (bias voltage/peripheral speed of the photoreceptor) and the amount of toner transferred from the developing roll 18 to the photoreceptor 7. Examples 1 to 3 and Comparative Example 1 are shown in the drawing. The peripheral speed of the photoreceptor 7 was 180 mm/sec. Thus, a high-speed image-forming apparatus 1 was attained.

As shown in FIG. 4, the transfer of toner from the developing roll 18 to the photoreceptor 7 was more favorable for Examples 1 to 3 in comparison with Comparative Example 1. Although not shown in FIG. 4, Examples 4 and 5 showed the same results as in Examples 1 to 3.

In Comparative Example 2 however, a problem arose in which leaking occurred. In Comparative Example 3, a problem arose in which the electric charge on the developing roll 18 could not be removed and toner accumulated on the developing roll 18. In Comparative Example 4, a problem arose in which the amount of toner delivered from the magnetic roll 17 to the developing roll 18 was insufficient and development irregularities occurred on the photoreceptor 7. In Comparative Example 5, a problem arose in which the contact area between the surface of the developing roll 18 and the toner increased, and toner therefore became more likely to remain on the developing roll 18.

As described above, toner can be easily separated from the surface of the developing roll 18 when the coating layer 18a of the surface of developing roll 18 is formed from silicone-modified polyurethane. In other words, the surface free energy of the silicone-modified polyurethane used as the coating layer 18a of the developing roll 18 is relatively low, and the adhesion between the developing roll 18 (silicone-modified polyurethane) and the toner is weak. It has become possible to attain a favorable transfer of toner from the developing roll 18 to the photoreceptor 7 even without increasing the bias voltage between the developing roll 18 and the photoreceptor 7. As a result, it has become possible to provide a image-forming apparatus 1 which allows both speed increase and image quality improvement.

When the surface specific resistivity of the coating layer 18a of the developing roll 18 is less than 10⁵Ω, the electric charge of the toner escapes (leaks), and noise and other adverse effects may occur in other electrical components. When the surface specific resistivity of the coating layer 18a of the developing roll 18 exceeds 10⁸Ω, no potential is applied to the toner and there is a possibility that a dielectric breakdown will occur. As explained above however, with image-forming apparatus 1 of the present embodiment, problems such as leaking or dielectric breakdown can be avoided by adjusting the surface specific resistivity of the coating layer 18a of the developing roll 18 to from 10⁵ and 10⁸ Ω. In addition, the toner can be smoothly delivered from the magnetic roll 17 to the developing roll 18 by adjusting the surface roughness Ra of the coating layer 18a of the developing roll 18 to from 0.4 to 1.5 μm, and the magnetic roll 17 can adequately scrape off the toner that remains on the surface of the coating layer 18a of the developing roll 18 and does not contribute to image developing.

In the present embodiment, the carrier particle diameter/toner particle diameter ratio was set to 45 μm/7.5 μm=6, and problems such as leaking or dielectric breakdown were also avoided by adjusting the Ra to from 0.4 to 1.5 μm. In addition, setting the carrier particle diameter/toner particle diameter ratio to greater than 4 but less than 10 along with adjusting the surface roughness Ra of the coating layer 18a as described above is preferred in order to be able to smoothly deliver toner from the magnetic roll to the developing roll and to scrape off the toner that remains on the surface of the coating layer of the developing roll and does not contribute to the developing of images. Magnetic brushes having appropriate stiffness and density can thereby be formed on the surface of the magnetic roll, and the toner remaining on the developing roll can be adequately scraped off by the magnetic roll.

The present invention is applicable to an image-forming apparatus in which images are developed using a two-component developer in electrophotographic apparatuses, copiers, printers, fax machines, and the like, and can also be used in other applications. Specific embodiments of the present invention were explained using drawings, but the embodiments were intended to be only examples, and the present invention is not limited by these embodiments.

1. An image-forming apparatus comprising:
a magnetic roll for magnetically holding a two-component developer in which toner and a magnetic carrier are electrostatically bonded;
a developing roll in which a thin layer of the toner transferred from the two-component developer on the magnetic roll is formed on a surface; and
a latent image support in which a latent image is developed with using the toner on the developing roll by a developing bias applied in relation to the developing roll; wherein
the developing roll has a coating layer composed of silicone-modified polyurethane on a surface.

2. The image-forming apparatus according to claim 1, wherein the coating layer composed of the silicone-modified polyurethane has a surface specific resistivity of 10⁵ to 10⁸Ω.

3. The image-forming apparatus according to claim 1, wherein the coating layer composed of the silicone-modified polyurethane has a surface roughness Ra of 0.4 to 1.5 μm.

4. The image-forming apparatus according to claim 1, wherein the coating layer composed of the silicone-modified polyurethane has a surface specific resistivity of 10⁵ to 108 Ω and a surface roughness Ra of 0.4 to 1.5 μm.

5. The image-forming apparatus according to claim 1, wherein an alternating-current bias is applied to the developing roll.

6. The image-forming apparatus according to claim 1, wherein the peripheral speed of the latent image support is 180 mm/sec or greater.
